(19) United States
(12) Patent Application Publication
(10) Pub. No.: US 2008/0127220 A1
(43) Pub. Date: May 29, 2008

(54) Methods, systems, and computer program products for creating an input-value-specific loadable instance of an application

(76) Inventor: Robert Paul Morris, Raleigh, NC (US)

Correspondence Address: SCENERA RESEARCH, LLC;JENKINS, WILSON & TAYLOR, P.A., 3100 TOWER BLVD, SUITE 1400, DURHAM, NC, 27707, US

(21) Appl. No.: 11/479,442

(22) Filed: Jun. 30, 2006

(51) Int. Cl. G06F 9/44

(52) U.S. Cl. 719/320; 715/700

(57) ABSTRACT

Methods, systems, and computer program products for creating an input-value-specific loadable instance of an application are disclosed. One method provides a graphical user interface (GUI) for receiving an identifier associated with an application. One or more metadata input parameters are identified and a value is received for each identified input parameter. A loadable instance of the application is created that, when invoked, loads the application into memory and provides the received values as input for processing by the application. The loadable instance is visually represented in the GUI. Another method stores a loadable instance of an application by creating a loadable instance and storing a reference to the application in the loadable instance, a reference to each metadata input parameter of the application, a value for each input parameter, and a visual representation of the loadable instance.

### TECHNICAL FIELD

The subject matter described herein relates to applying user configurations to applications. More particularly, the subject matter described herein relates to methods, systems, and computer program products for creating an input-value-specific loadable instance of an application.

### BACKGROUND

In computer systems, applications include one or more executable files containing instructions capable of controlling a processor to perform a task, as well as other files accessed in conjunction with the executable file(s), such as a variety of data and/or configuration files, dynamic link library (DLL) files, and the like. Conventional applications typically provide a number of configuration options and available functions in order to optimize use of the application for a variety of tasks. However, as will be described in detail below, these configuration options are limited and do not all the creation of customized instances of the application to perform different tasks. It may be desirable to configure an application such that, when invoked, the application operates in a customized manner to accomplish a specific task. For example, a user may wish to customize a word processing application based on the type of document that the application is to generate.

Conventional applications have limited means and resources available to support such customizations. For example, a user may only be permitted to make configuration adjustments once the application has started. If the user requires different settings for these definitions, the settings must be changed before starting work on a data file. Additionally, some applications may include options for presetting some of the functional properties of the application. For example, a drawing application may provide configuration options to define the format of a page, the default type font and size, and/or the default line width. However, these options are typically limited, tightly bound to the application itself, do not include mechanisms to define a plurality of user profiles, and do not provide a means of automatically invoking other applications.

Conventional applications typically do not provide means for saving values of output parameters for use in a subsequent application session. Some applications may support a predefined data file comprising output parameter values and/or use other means such as a database for storing application-generated instance values. However, these resources typically comprise data in a format proprietary to the application and may not easily be shared with other applications.

Some conventional systems may include mechanisms to permit a user to define certain properties for a system resource, a data file, or a folder containing the application or data file. Property definitions associated with data files and folders are typically very limited in scope and tightly bound to the data file or folder structure. For example, a file system may provide a mechanism to define users that have permission to access a data file or a mechanism to define a specific version of an application software package to be associated with the data file.

Accordingly, in light of the above described difficulties associated with existing methods for configuring applications, there exists a need for improved methods, systems, and computer program products for creating an input-value-specific loadable instance of an application.

### SUMMARY

According to one aspect, the subject matter described herein includes methods, systems, and computer program products for creating an input-value-specific loadable instance of an application. One method provides a graphical user interface (GUI) for receiving an identifier associated with an application. Metadata associated with the application are accessed, and at least one input parameter of the application that may receive a value is identified. The at least one input parameter is presented at the GUI, and a value is received for the at least one input parameter. A loadable instance of the application is created that, when invoked, loads the application into memory and provides the at least one received value as input for processing by the application. The loadable instance is capable of being visually represented.

Another method stores a loadable instance of an application by creating a loadable instance and storing a reference to an application in the loadable instance. A metadata parameter field identifier is stored in the loadable instance to identify at least one input parameter of the application. A value is stored for the at least one input parameter, and a visual representation of the loadable instance is stored.

As used herein, the term “loadable instance” refers to an autonomous system resource including a reference to an application, one or more metadata parameters for the application, an instance value for each metadata parameter, and a reference to a display icon for the instance. Instance values provided for metadata parameters input to the application may either be system default values or values supplied by a user. Metadata output parameter instance values may be supplied by the most recently completed instantiation of the application. The loadable instance may be of any form suitable to the host system, including a database entry, a record, or a linked list of values and references.

As used herein, the term “complex loadable instance” refers to a loadable instance comprising references to a plurality of applications, one or more metadata parameters for each application, an instance value for each metadata parameter, and a reference to a display icon for the instance. Instance values provided for metadata parameters input to the application may either be system default values or values supplied by a user. Metadata output parameter instance values may be supplied by the most recently completed instantiation of the application. The complex loadable instance may be of any form suitable to the host system, including a database entry, a record, or a linked list of values and references.

As used herein, the term “instance manager” refers to an entity that manages at least one loadable instance.

As used herein, the term “application” refers to a software product in object code format that may run when invoked by a user without additional compilation The application may include multiple files that may be stored in a memory storage medium on a host computer system, including main memory or a persistent storage device, such as a hard drive. The application may also be stored on a remote computer.

As used herein, the term “application instance” refers to a copy of an application placed in a section of main memory reserved for active instances of applications and whose metadata parameter fields have not been populated with parameter values from a loadable instance.

As used herein, the term “active customized instance” refers to an application instance comprising specified instance values for metadata parameters that have been copied from a loadable instance by an instance manager before the instance is initialized to run.

The subject matter described herein may be implemented using a computer program product comprising computer executable instructions embodied in a computer-readable medium. Exemplary computer-readable media suitable for implementing the subject matter described herein include chip memory devices, disk memory devices, programmable logic devices, application specific integrated circuits, and downloadable electrical signals. In addition, a computer-readable medium that implements the subject matter described herein may be distributed as represented by multiple physical devices and/or computing platforms.

### BRIEF DESCRIPTION OF THE DRAWINGS

Preferred embodiments of the subject matter described herein will now be explained with reference to the accompanying drawings of which:

FIG. 1 is a block diagram of an exemplary host system comprising at least one loadable instance, an application referenced by the loadable instance, a data file resource associated with the application, and a display icon referenced by the loadable instance according to an embodiment of the subject matter described herein;

FIG. 2 is a block diagram of an exemplary host system comprising an instance manager, a loadable instance database, an active customized instance in a system memory, and a plurality of resident applications according to an embodiment of the subject matter described herein;

FIG. 3 is a flow chart of an exemplary process to create an input-value-specific loadable instance of an application according to an embodiment of the subject matter described herein;

FIG. 4 is a flow chart of an exemplary process for associating a loadable instance of an application with an input value according to an embodiment of the subject matter described herein;

FIG. 5 is a flow chart of an exemplary process for instantiating an active customized instance of an application in response to invocation of the application according to an embodiment of the subject matter described herein;

FIG. 6 is a flow chart of an exemplary process for instantiating of an active customized instance of an application in response to invocation of a system resource referenced to the application according to an embodiment of the subject matter described herein;

FIG. 7 is a block diagram of an exemplary instance manager including a complex loadable instance referencing a plurality of applications according to an embodiment of the subject matter described herein;

FIG. 8 is a flow chart of an exemplary process to create a complex loadable instance according to an embodiment of the subject matter described herein;

FIG. 9 is a flow chart of an exemplary process for instantiating an active customized instance for each of a plurality of applications referenced in a complex loadable instance in response to invocation of an referenced application according to an embodiment of the subject matter described herein;

FIG. 10 is a flow chart of an exemplary process for instantiating an active customized instance for each of a plurality of applications referenced in a complex loadable instance in response to invocation of a system resource associated with a referenced application according to an embodiment of the subject matter described herein;

FIG. 11 is an exemplary graphical user interface (GUI) display of a plurality of display icons, each of which may be associated with a loadable instance of an application according to an embodiment of the subject matter described herein;

FIG. 12 is an exemplary GUI dialog box configured to permit a user to associate a loadable instance to an application according to an embodiment of the subject matter described herein;

FIG. 13 is an exemplary GUI dialog box to permit a user to associate an application or a system resource, plus at least one metadata parameter, to a loadable instance of an application according to an embodiment of the subject matter described herein;

FIG. 14 is an exemplary GUI dialog box to permit a user to associate a system resource to a loadable instance of an application according to an embodiment of the subject matter described herein; and

FIG. 15 is a flow chart of an exemplary process for instantiating and running a first active customized instance of an application, storing an instance value for at least one metadata output parameter for the application, terminating the first active instance, and, in response to termination of the first active instance, instantiating and running a second instance of the active customized instance utilizing the instance values of the at least one output parameter generated by the first active instance as an input to the second active instance according to an embodiment of the subject matter described herein.

### DETAILED DESCRIPTION

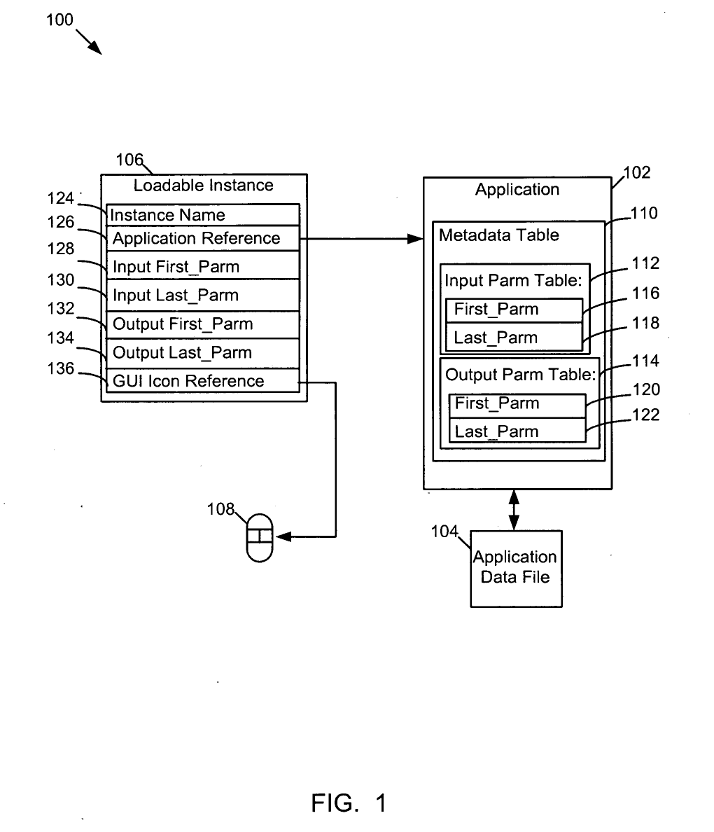

The subject matter described herein includes methods, systems, and computer program products for creating an input-value-specific loadable instance of an application. A plurality of loadable instances may be collected and maintained in an instance manager, each of which may be a system resource created by a user and maintained independent of any application in the host system. FIG. 1 is an illustration of an exemplary host system 100 comprising an application 102, an associated data file 104, a loadable instance 106, and a display icon 108 referenced by instance 106 according to an embodiment of the subject matter described herein. For example, system 100 may permit configuration of a word processing loadable instance for a specific text editing task such as preparation of a technical paper, defining input parameters such as page length, column width, default font size, and/or default font style. In FIG. 1, data file 104 and loadable instance 106 may be managed as resources in host system 100 associated with application 102. Logical associations may be defined among these resources using any means suitable to host system 100. For example, data file 104 may be associated with application 102 through a specified file name extension and/or through an association table maintained in host system 100.

Application 102 may include a reference to input and output metadata parameters. In the example shown in FIG. 1, application 102 includes a metadata table 110 comprising an input parameter table 112 and/or may include an output parameter table 114. It should, however, be understood, that the input and output metadata parameters and the associated values can be stored, referenced, maintained, associated, etc., within application 102 (as shown), such as in a descriptor file associated with application 102, or without application 102 (not shown), such as within a file system, database, or the like, associated with application 102. According to the embodiment illustrated in FIG. 1, input parameter table 112 may include a plurality of parameter fields including a first parameter field 116 and a last parameter field 118. For example, metadata input parameters for a word processing application may define font size, font style, margins, or colors used in various parts of the GUI display. Output parameter table 114 may include a plurality of parameter fields including a first parameter field 120 and a last parameter field 122 whose contents may present status information from application 102 at termination of an application session. For example, metadata output parameters for a word processing application may include the name of data file 104 used during the session, the number of characters in the data file, and the number of times the file has been accessed for editing. The number of parameter fields and the significance of values populated in each field of table 112 and/or table 114 may be defined by application 102.

Loadable instance 106 may comprise a plurality of information fields including a name field 124, an application reference field 126, a plurality of metadata input parameter fields including an input first parameter field 128 and an input last parameter field 130, a plurality of metadata output parameter fields including an output first parameter field 132 and an output last parameter field 134, and a GUI icon reference field 136. Each input field may reference a value suitable for use as input for the associated parameter.

Name field 124 may be populated with any identifier suitable to host system 100. For example, the contents of field 124 may be in the form of an ASCII character string.

Application reference field 126 may contain a reference to application 102 referenced by the loadable instance 106. For example, field 126 may be populated with a pointer, a URL, a file directory path, a direct application invocation command, or any other reference indicator suitable to host system 100 and application 102.

The number of metadata input fields and metadata output fields included in instance 106 may be defined during the creation of instance 106. A list of metadata parameters may be obtained from parameter schema information associated with the application. The schema information specifies valid input and/or output parameters and values, and may be stored in a file or descriptor associated with the application through a variety of means. For example, the schema information may be in a file with the same name but a different file extension than the application which identifies the file as a schema information file. In another exemplary application, the schema information may be in a file in a known location relative to the location of the application, or the schema information may be in a datastore accessed using a key derived from application information. Additionally, the schema information may be obtained directly from application 102 using any means suitable to application 102 and host system 100. For example, a metadata descriptor file for the application can be read to determine the list of metadata parameters. Instance 106 may be populated with one data field for each metadata input and/or output parameter identified by application 102. For example, if application 102 identified two metadata input parameter fields input_first_parm 116 and input_last_parm 118, instance 106 may include input_first_parm field 128 and input_last_parm field 130 containing instance values for metadata parameters 116 and 118. As another example, if application 102 identified two metadata output parameter fields output_first_parm 120 and output_last_parm 122, instance 106 may include output_first_parm field 132 and output_last_parm field 134 to reference resulting values generated by application 102 during a session.

GUI icon reference field 136 may contain a reference to display icon 108. For example, field 136 may be populated with a pointer, a URL, a file directory path, a local file invocation, or any other reference indicator suitable to host system 100 and icon 108.

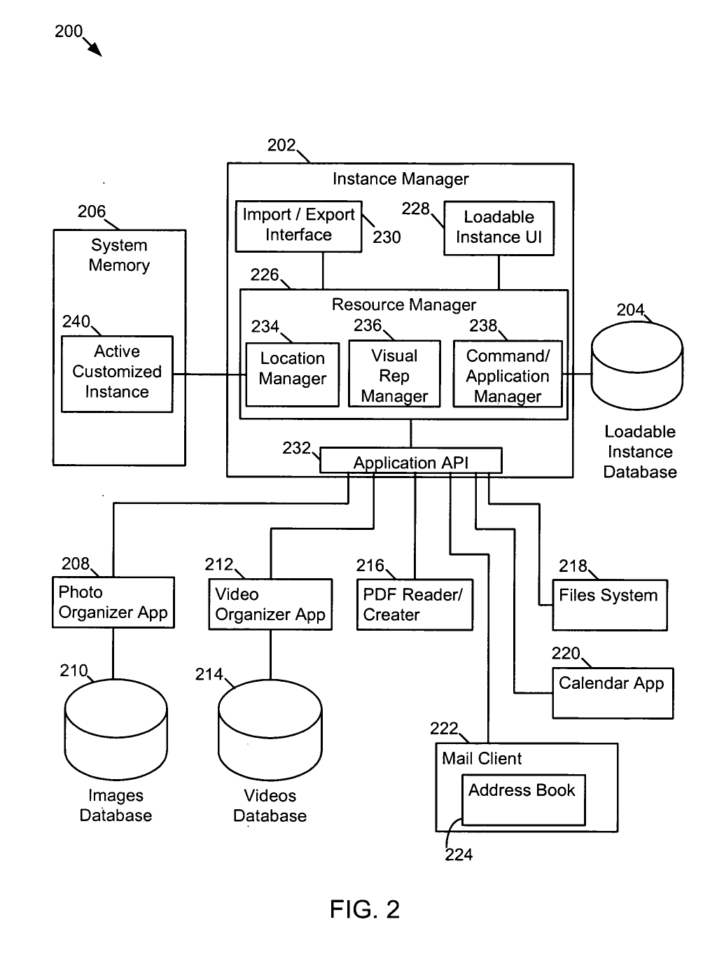

FIG. 2 is a block diagram of an exemplary host system 200 comprising an instance manager 202, a loadable instance database 204, and a system memory resource 206. In FIG. 2, a plurality of applications may be resident in host system 200, including a photograph organizer 208 with associated database 210, a video organizer 212 with associated database 214, a PDF file reader and generator 216, a secondary files system 218, a calendar application 220, and an email client 222 including address book 224.

Instance manager 202 may comprise a resource manager 226, a loadable instance user interface (UI) 228, a file import/export interface 230, and an application programming interface (API) resource 232.

Resource manager 226 may provide methods and resources to manage at least one loadable instance 106, at least one display icon 108, at least one application 102, and one or more definitions of relationships among the resources referenced in each instance 106. Resource manager 226 may interact with host system 200 in order to define instantiations of the plurality of logical associations among instance 106, referenced application 102, and/or data file 104 associated with application 102. Resource manager 226 may also include a database management resource to control the contents, organization, and format of the at least one instance 106 stored in database 204.

Resource manager 226 may further comprise a location manager 234, a visual representation manager 236, and a command/application manager 238. Location manager 234 may comprise a path definition for each system resource that may be referenced in loadable instance 106. For example, location manager may comprise one or more pointers to a display icon 108, an application 102, and/or a host system 200 file structure. Visual representation manager 236 may provide resources to retrieve one or more display icon image files, directories, and/or other system resource display information, and to organize the available display resources for a GUI screen through user interface 228. Command/application manager 238 may comprise a path definition for the application 102 referenced in instance 106. Command/application manager 236 may also include application scripts to permit instance manager 202 to obtain all metadata input and output parameter identifiers from an application 102.

Loadable instance UI 228 may include means suitable to host system 200 for displaying the contents of instance 106, icons representing resources referenced in instance 106, and/or system resources associated with application 102 referenced in instance 106. For example, instance manager 202 may present a display screen through UI 228 in order to prompt a user to supply instance values for fields in instance 106. UI 228 may also include means suitable for host system 200 to receive input from a user via a system input device such as a keyboard or mouse.

Import/export interface 230 may include resources to receive one or more instances 106 from a remote source and/or to transmit one or more instances 106 to a remote destination using any means suitable to host system 200. For example, interface 230 may utilize an XML or SQL script to configure a transfer message and utilize a trivial FTP session to transfer the file to a receiving instance manager 202 at a remote host system.

API 232 may include mechanisms to permit one or more application 102 to interact with instance manager 202. For example, an application 102 may send a request through API 232 to resource manager 236 for a list of each instance 106 whose application reference field 126 references application 102, in order to display a list of available loadable instances on a GUI display. In a second exemplary application, application 102 may use procedures in API 232 to facilitate storage of application-generated output results for metadata parameters to an instance 106 associated with the application 102. In yet another exemplary application, resource manager 226 may utilize procedures in API 232 to obtain metadata parameters from application 102 referenced to instance 106.

Database 204 may provide storage for the one or more loadable instances 106 created and managed by instance manager 202. The format and contents of the one or more instances 106 in database 204 may be of any means suitable to instance manager 202 and host system 200.

System memory resource 206 may comprise space allocated to one or more active customized instances 240. Each instance 240 may be a loadable instance 106 comprising a copy of a system application 102 whose metadata parameters have been instantiated with specific instance values.

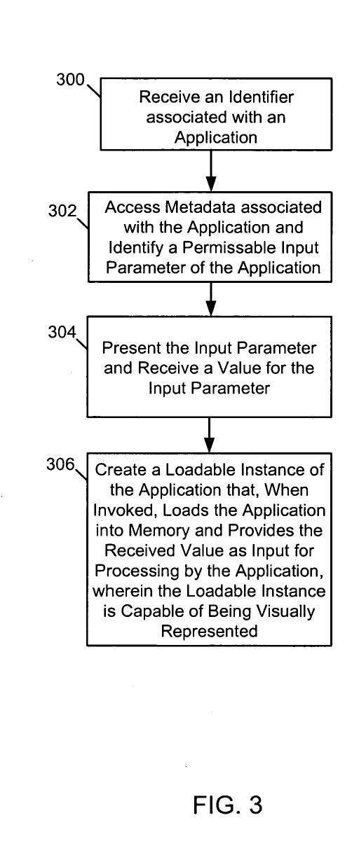

FIG. 3 is a flow chart of an exemplary process for creating an input-value-specific loadable instance 106 of an application 102 according to an embodiment of the subject matter described herein. In FIG. 3 at block 300, instance manager 202 receives an identifier associated with an application 102 through UI 228. For example, an icon associated with application 102 may be activated by a user on a GUI screen.

At block 302, instance manager 202 accesses metadata associated with application 102 and identify a metadata input parameter of the application that may receive an instance value. Instance manager 102 may implement the access using any means suitable to host system 200 including sending a request to application 102 for a list of metadata parameters and receiving at least one parameter identifier in response.

At block 304, instance manager 202 presents the at least one metadata input parameter on a GUI screen and receive an instance value for the input parameter. Instance manager 202 may present the at least one input parameter to the GUI through UI 228, and may receive the instance value from an input device controlled by host system 200 through UI 228. Input parameters not receiving an instance value from an input device may be assigned a system default value.

At block 306, instance manager 202 creates a loadable instance of application 102 that, when invoked, loads a copy of application 102 into system memory 206 and provides the received instance value for the at least one input parameter as input for processing by application 102 as an active customized instance 240. The loadable instance of application 102 may comprise a reference to a display icon 108 or similar visual representation. For example, a loadable instance 106 may be created comprising a reference to an email application, metadata input parameter instantiations providing an account name, password, and/or email server, and a reference to an email icon with a specific application name such as “Business Email”.

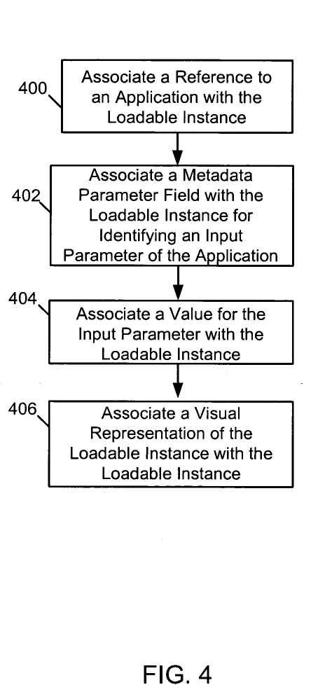

FIG. 4 is a flow diagram of an exemplary process associating a loadable instance 106 of an application 102 with an input value according to an embodiment of the subject matter described herein. In FIG. 4, instance manager 202 may create a loadable instance 106 using, for example, procedures associated with blocks 300-306. The loadable instance includes at least one reference for associating with the loadable instance each of the application, a metadata parameter field for identifying an input parameter of the application, a value for the input parameter to be provided as input for processing by the application when the loadable instance is invoked, and a visual representation of the loadable instance for allowing invocation of the loadable instance via a user interface.

At block 400, instance manager 202 associates a reference to an application with the loadable instance. For example, instance manager 202 may store the contents of application reference field 126 for loadable instance 106 in database 204. In another exemplary application, loadable instance 106 in instance manager 202 may include a copy of the application and/or immediate values for one or more parameters 128-134. The method and organization of storage for application reference field 126 may be of any means suitable to instance manager 202, host system 200, and database 204.

At block 402, instance manager 202 associates a metadata input parameter field with loadable instance 106, for example, using database 204. The method and organization of storage for the at least one metadata input parameter field identifiers may be of any means suitable to instance manager 202, host system 200, and database 204.

At block 404, instance manager 202 associates a value for the input parameter, for example, using loadable instance fields 128-130 in database 204. The method and organization of storage for the at least one instance values may be of any means suitable to instance manager 202, host system 200, and database 204.

At block 406, instance manager 202 associates a visual representation of the loadable instance with the loadable instance. For example, instance manager 202 may store the contents of GUI icon field 136 from loadable instance 106 in database 204. The method and organization of storage for instance name field 124 may be of any means suitable to instance manager 202, host system 200, and database 204.

### Exemplary Loadable Instance Methods

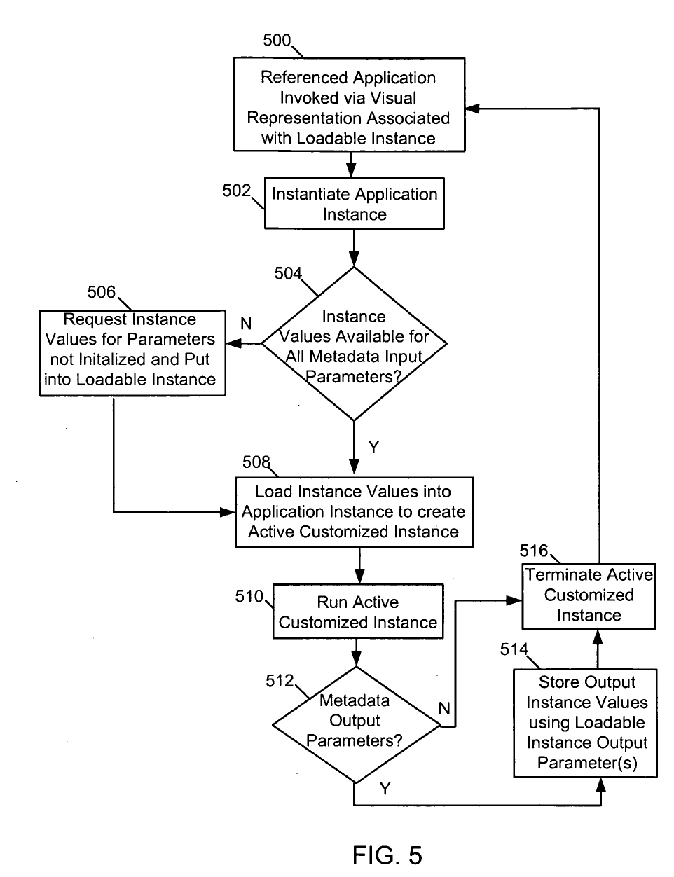

FIG. 5 is a flow diagram of an exemplary process for instantiating an active customized instance 240 of an application 102 in response to invocation of the application 102 according to an embodiment of the subject matter described herein. For example, host system 200 may invoke application 102 in response to activation of a GUI icon associated with the application. In FIG. 5, at block 500 instance manager may receive an indication that application 102 has been invoked by host system 200.

At block 502, instance manager 202 may create an application instance of application 102 by placing a copy of application 102 into system memory 206.

At decision point 504, instance manager 202 may check the contents of each metadata input parameter field in a loadable instance 106 associated with application 102 to determine if the field contains an instance value provided at block 304 when the loadable instance was created. If each metadata input field in the selected loadable instance 106 contains an instance value, the process may proceed to block 508. If one or more input fields in instance 106 contain no specified value and have no associated default value, the process may proceed to block 506.

At block 506, instance manager 202 may display each metadata input parameter for which instance 106 does not already contain an instance value. This display may be provided through UI 228 and may also include a prompt requesting input from the user. Instance manager 202 may add any instance values received for the displayed metadata input parameters into loadable instance 106 stored in database 204.

At block 508, instance manager 202 may create an active customized instance 240 by loading a copy of the instance value for each metadata input parameter available from loadable instance 106 into the application instance placed in system memory 206 at block 502.

At block 510, active customized instance 240 may initialize, run, and terminate its operating session using any means suitable to host system 200. Active instance 240 may access an application data file 104 associated with application 102 to either read or write contents as appropriate. For example, active instance 240 may provide a word processing function for host system 200 with certain environment options set according to the task that the user wishes to complete. In response to initialization, active instance 240 and instance manager 202 may also display any input metadata parameters not initialized by loadable instance 106 at block 506 or 508 through UI 228 to solicit user input during processing of the active loadable instance.

At decision point 512, active customized instance 240 may determine if any operational result values are to be generated and stored via metadata output parameters. If so, the process may proceed to block 514; otherwise, the process may proceed to block 516.

At block 514, active customized instance 240 may generate at least one operational result and transfer the at least one result to instance manager 202 for storage in metadata output parameter fields 132-134 in loadable instance 106. Instance manager 202 may store the received results in database 204 in loadable instance 106 fields 132-134. The method and organization of storage for the at least one metadata output parameter field contents may be of any means suitable to instance manager 202, host system 200, and database 204.

At block 516, active customized instance 240 may terminate operation using any suitable means. In response to termination of active instance 240, instance manager 202 and database 204 may close instance 106. The process may proceed to block 500 and wait for another invocation of application 102.

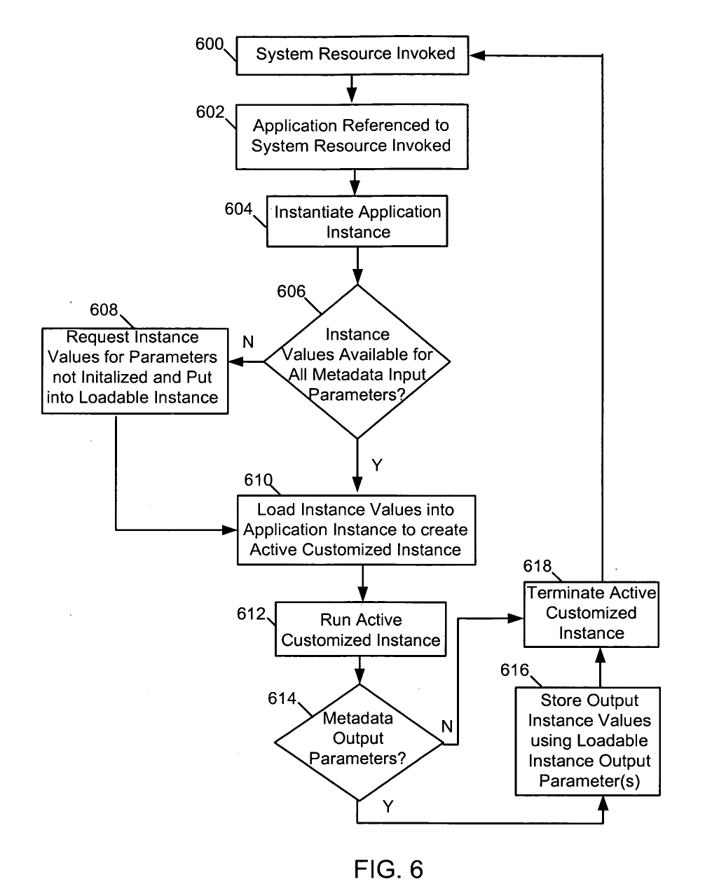

FIG. 6 is a flow diagram of an exemplary process for instantiating an active customized instance 240 of an application 102 through invocation of a system resource associated with loadable instance 106 according to an embodiment of the subject matter described herein. For example, a system resource may be an application data file 104 associated with loadable instance 106 by any means suitable to file 104, loadable instance 106, and host system 200.

At block 602 host system 200 may invoke application 102 associated with the loadable instance 106 through invocation of system resource. For example, application 102 may be invoked through an application data file 104 using a resource/loadable instance link defined and maintained by host system 200 using loadable instance 106 association with application 102

At block 604, in response to invocation of application 102 by host system 200, instance manager 202 may create an application instance of application 102 by placing a copy of application 102 into system memory 206.

At decision point 606, instance manager 202 may check the contents of each metadata input parameter field in a loadable instance 106 associated with application 102 to determine if the field contains a user supplied instance value. If each metadata input field in instance 106 contains an instance value provided at block 304, the process may proceed to block 610. If one or more input fields in instance 106 contain no specified value and have no associated default value, the process may proceed to block 608.

At block 608, instance manager 202 may display each metadata input parameter for which instance 106 does not already contain an instance value. This display may be provided through loadable instance UI 228 and may also include a prompt requesting input from the user. Instance manager 202 may add instance values for the displayed metadata input parameters to instance 106.

At block 610, instance manager 202 may create an active customized instance 240 by loading a copy of the instance value for each metadata input parameter available from instance 106 into the application instance placed in system memory 206 at block 602.

At block 612, active customized instance 240 may initialize, run, and terminate its operating session using any means suitable to host system 200. Active instance 240 may access an application data file 104 associated with application 102 to either read or write contents as appropriate. For example, active instance 240 may provide a spreadsheet function for host system 200 with certain environment options set and/or groups of functions enabled according to the task that the user wishes to complete. In response to initialization, active instance 240 and instance manager 202 may also display any input metadata parameters not initialized by loadable instance 106 at block 608 through UI 228 to solicit user input during the processing of application 102.

At decision point 614, active instance 240 may determine if any operational result values are to be generated and stored in metadata output parameters. If so, the process may proceed to block 614; otherwise, the process may proceed to block 616.

At block 616, active instance 240 may generate at least one operational result and transfer the at least one result to instance manager 202 for storage via metadata output parameter fields 132-134 in instance 106. Instance manager 202 may store the received results in database 204 in loadable instance 106 fields 132-134. The method and organization of storage for the at least one metadata output parameter field contents may be of any means suitable to instance manager 202, host system 200, and database 204.

At block 618, active customized instance 240 may terminate operation using any suitable means. In response to termination of active instance 240, instance manager 202 and database 204 may close instance 106.

### Exemplary Complex Loadable Instance

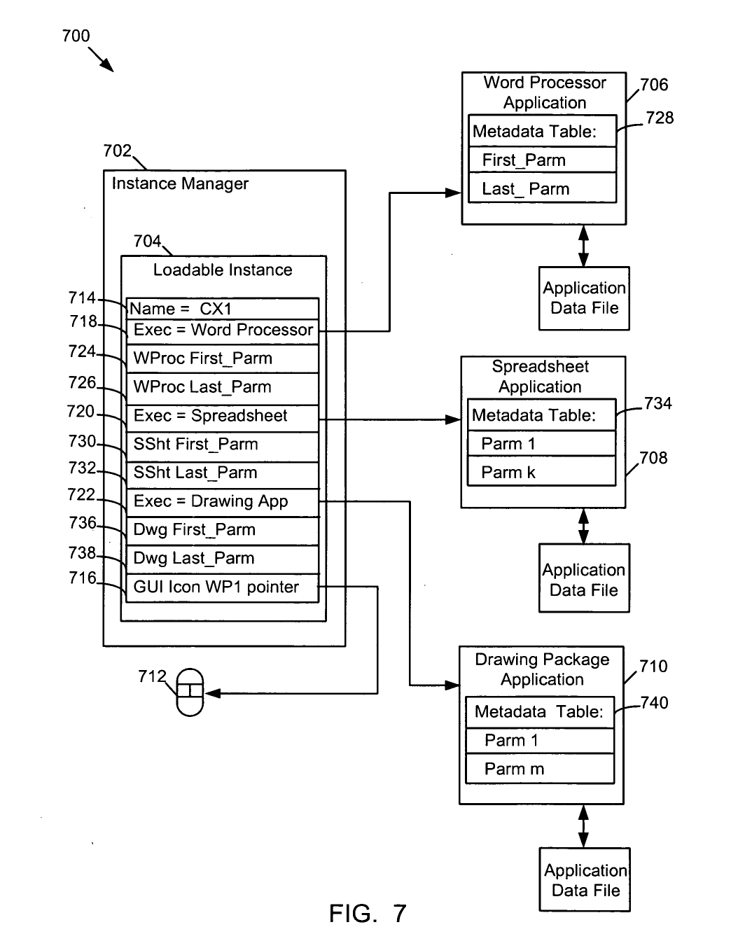

FIG. 7 is a diagram of an exemplary host system 700 comprising an instance manager 702 including a complex loadable instance 704, three applications 706, 708, and 710, plus display icon 712 according to an embodiment of the subject matter described herein. Complex instance 704 may define explicit associations among a plurality of applications required for a higher-level task. In FIG. 7, complex instance 704 may comprise a plurality of fields including an instance name field 714, a GUI icon reference field 716, and a plurality of application reference fields 718, 720, and 722. Instance 704 may further comprise a field corresponding to each metadata parameter defined in each application.

For example, complex instance 704 may include references to three applications: a word processing application 706, a spreadsheet application 708, and a drawing package application 710. In complex instance 704, application reference field 718 may contain a reference to word processing application 706, and at least one field 724-726 may comprise an instance value for metadata parameters defined in metadata table 728 for application 706. Application reference field 720 may contain a reference to spreadsheet application 708, and at least one field 730-732 may comprise an instance value for metadata parameters defined in metadata table 734 for application 708. Application reference field 722 may contain a reference to drawing package application 710, and at least one field 736-738 may comprise an instance value for metadata parameters defined in metadata table 740 for application 710.

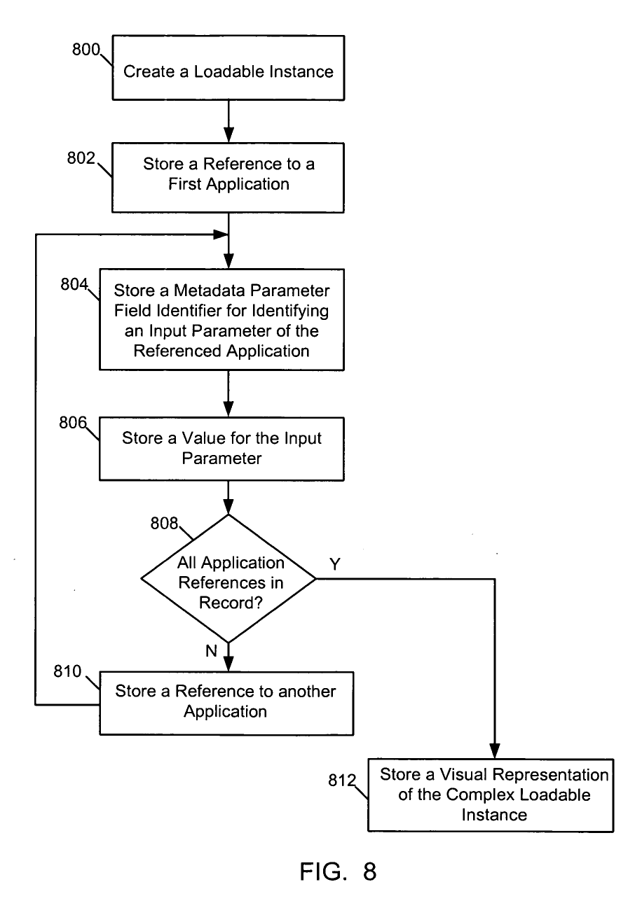

FIG. 8 is a flow chart of an exemplary process for creating a complex loadable instance 704 in instance manager 702 according to an embodiment of the subject matter described herein. In FIG. 8, at block 800, instance manager 202 may create a new loadable instance 704 using procedures associated with blocks 300-306 and may store the contents of instance name field 714. The method and organization of storage for instance name field 714 may be of any means suitable to instance manager 202, host system 200, and database 204.

At block 802, instance manager 202 may store the contents of a first application reference field 718 for loadable instance 704 in database 204. The method and organization of storage for application reference field 718 may be of any means suitable to instance manager 202, host system 200, and database 204.

At block 804, instance manager 202 may store the at least one metadata input parameter field identifiers associated with an application referenced in loadable instance 704 in database 204. The method and organization of storage for the at least one metadata input parameter field identifiers may be of any means suitable to instance manager 202, host system 200, and database 204.

At block 806, instance manager 202 may store the instance value provided for the at least one metadata input parameter field identifier in database 204. The method and organization of storage for the at least one instance values may be of any means suitable to instance manager 202, host system 200, and database 204.

At decision point 808, instance manager may determine if all required application references and associated metadata input parameter fields and values have been stored in database 204 for complex instance 704. If so, the process may proceed to block 812; otherwise, the process may proceed to block 810 to add another application reference and at least one metadata input parameter field.

At block 810, instance manager 202 may store the contents of another application reference field for complex loadable instance 704 in database 204. The method and organization of storage for the application reference field may be of any means suitable to instance manager 202, host system 200, and database 204. The process may then proceed to block 804 to store a metadata parameter identifier for the application identified at block 810.

At block 812, instance manager 202 may store the contents of GUI icon field 716 from loadable instance 704 in database 204. The method and organization of storage for GUI icon reference field 716 may be of any means suitable to instance manager 202, host system 200, and database 204.

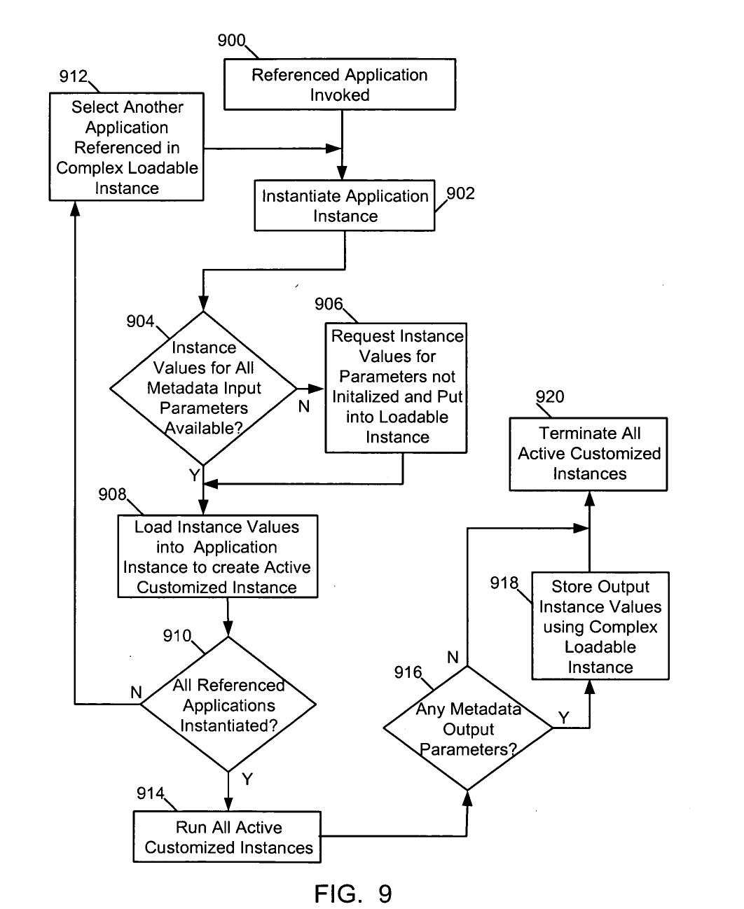

FIG. 9 is a flow diagram of an exemplary process for instantiating an active customized instance 240 for each of a plurality of applications referenced in a complex loadable instance 704 in response to invocation of an application 102 referenced in complex instance 704 according to an embodiment of the subject matter described herein. In FIG. 9, at block 900 an application 102 referenced in complex loadable instance 704 may be invoked through host system 200. For example, host system 200 may invoke application 102 in response to activation of an icon through a standard input device, the icon associated with complex loadable instance 704 via a reference to application 102, or application 102 may be invoked in response to activation of another system resource associated with complex loadable instance 704.

At block 902, instance manager 202 may create an application instance of the application 102 invoked at block 902 by placing a copy of the application 102 into the system memory 206 in an application format.

At decision point 904, instance manager 202 may check the contents of each metadata input parameter field in complex instance 704 comprising a reference to the application instance invoked at block 902 to determine if the field contains an instance value. If each metadata input field in complex instance 704 associated with the application instantiated at block 902 contains an instance value, the process may proceed to block 908. If one or more input fields in complex instance 704 contain no specified value and have no associated default value, the process may proceed to block 906.

At block 906, instance manager 202 may display each metadata input parameter associated with the application reference checked at decision point 904 for which complex instance 704 does not already contain an instance value. This display may be provided through UI 228 and may also include a prompt requesting input from the user. Instance manager 202 may add any instance values received for the displayed metadata input parameters into complex instance 704 stored in database 204 for use in subsequent instantiations.

At block 908, instance manager 202 may create an active customized instance 240 for the application instance created at block 902 by loading a copy of the instance value for each metadata input parameter available from complex instance 704 into the application instance placed in system memory 206 at block 902.

At decision point 910, instance manager may review complex instance 704 to determine if an active customized instance 240 has been created for each referenced application 102. If all required active instances 240 have been created, the process may proceed to block 914. If not, the process may proceed to block 912 to select the next application reference for which an application instance is to be created, and then proceed to block 902 to instantiate the selected application instance.

At block 914, each active customized instance 240 may initialize, run, and terminate its operating session using any means suitable to host system 200. In response to initialization, each active instance 240 and instance manager 202 may display any input metadata parameters not initialized by loadable instance 704 at block 906 through UI 228 to solicit user input during processing of any of the applications Each active instance 240 may access an associated application data file 104 to either read or write contents as appropriate.

At decision point 916, each active customized instance 240 may determine if any operational result values are to be generated and stored via metadata output parameters. If any active instance 240 has output parameter instance values, the process may proceed to block 918; otherwise, the process may proceed to block 920.

At block 918, each active customized instance 240 comprising instance values for metadata output parameters may generate at least one operational result and transfer the at least one result to instance manager 202 for storage as specified by metadata output parameter fields in complex instance 704. Instance manager 202 may store these results in database 204 for complex instance 704.

At block 920, each active customized instance 240 may terminate operation using any suitable means. In response to termination of all active instances 240, instance manager 202 and database 204 may close complex instance 704

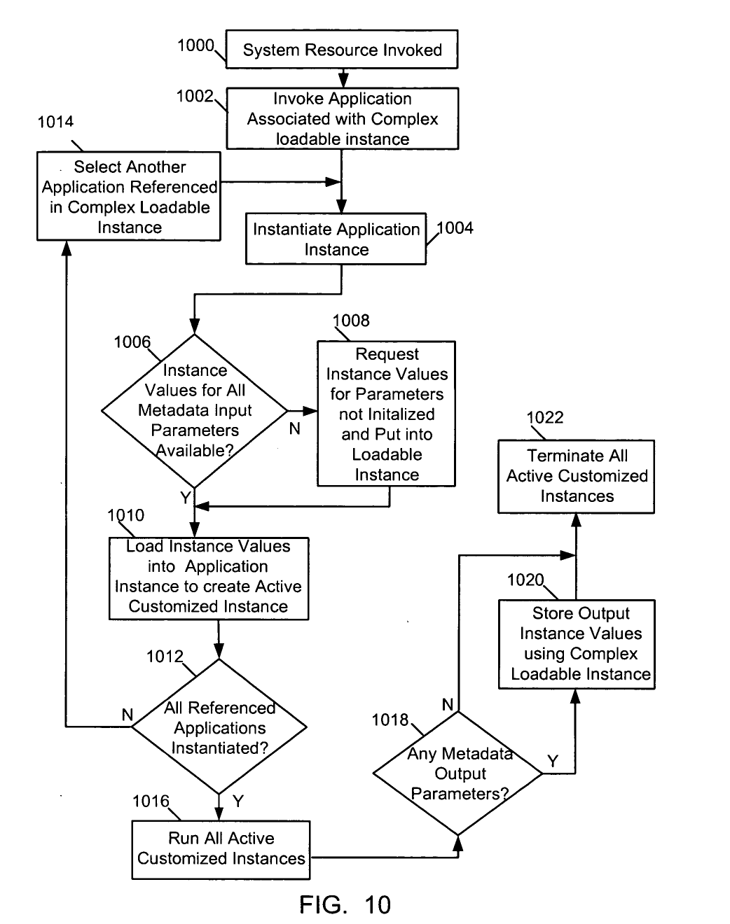

FIG. 10 is a flow diagram of an exemplary process for instantiating an active customized instance 240 for each of a plurality of applications referenced in a complex loadable instance 704 in response to invocation of an action associated with the resource where the action is associated with the complex instance 704 according to an embodiment of the subject matter described herein. For example, a system resource may be an application data file 104 associated with complex loadable instance 704 that references application 102 by any means suitable to the data file, complex loadable instance 704, application 102, and host system 200. In a second exemplary application, a system resource may be a complex loadable instance 704 which may be accessed through activation of a referenced icon 712. In FIG. 10, at block 1000, a system resource may be invoked either by an external user or by another application resident in host system 200.

At block 1002, host system 200 may invoke loadable instance 704 through associations defined for the system resource invoked at block 1002. For example, a loadable instance 704 may be invoked through an associated application data file 104 using a resource/loadable instance link defined and maintained by the host system

At block 1004, instance manager 202 may create an instance of application 102 associated with complex loadable instance 704 invoked at block 1002 by placing a copy of the application 102 into system memory 206.

At decision point 1006, instance manager 202 may check the contents of each metadata input parameter field in complex instance 704 associated with the application instance instantiated at block 1004 to determine if the field contains an instance value. If each metadata input field in instance 704 contains an instance value, the process may proceed to block 1010. If one or more input fields in complex instance 704 contain no specified value and have no associated default value, the process may proceed to block 1008.

At block 1008 instance manager 202 may display each metadata input parameter associated with the application reference checked at decision point 1006 for which complex instance 704 does not already contain an instance value. This display may be provided through UI 228 and may also include a prompt requesting input from the user. Instance manager 202 may add any instance values received for the displayed metadata input parameters into complex instance 704.

At block 1010, instance manager 202 may create an active customized instance 240 for the application instance created at block 1004 by loading a copy of the instance value for each metadata input parameter available from complex instance 706 into the application instance placed in system memory 206 at block 1004.

At decision point 1012, instance manager may review the application reference fields in complex instance 704 to determine if an active customized instance 240 has been created for each referenced application 102. If all required active instances 240 have been created, the process may proceed to block 1016. If not, the process may proceed to block 1014 to select another application reference for which an application instance is to be created, and then proceed to block 1004 to instantiate the selected application instance.

At block 1016, each active customized instance 240 may initialize, run, and terminate its operating session using any means suitable to host system 200. In response to initialization, each active instance 240 and instance manager 202 may display any input metadata parameters not initialized by loadable instance 704 at block 1008 through UI 228 to solicit user input during the processing of the active loadable instance in step 1016. Each active instance 240 may access an associated application data file 104 to either read or write contents as appropriate.

At decision point 1018, each active customized instance 240 may determine if any operational result values are to be generated and stored via metadata output parameters. If so, the process may proceed to block 1020; otherwise, the process may proceed to block 1022.

At block 1020, each active customized instance 240 comprising at least one metadata output parameter may generate at least one operational result and transfer the at least one result to instance manager 202 for storage using the metadata output parameter fields in complex instance 704. Instance manager 202 may store the at least one received instance value in database 204 for complex instance 704.

At block 1022, each active customized instance 240 may terminate operation using any suitable means. In response to termination of all active instances 240, instance manager 202 and database 204 may close complex instance 704 and store an updated copy in database 204.

### Exemplary Graphical User Interface Displays

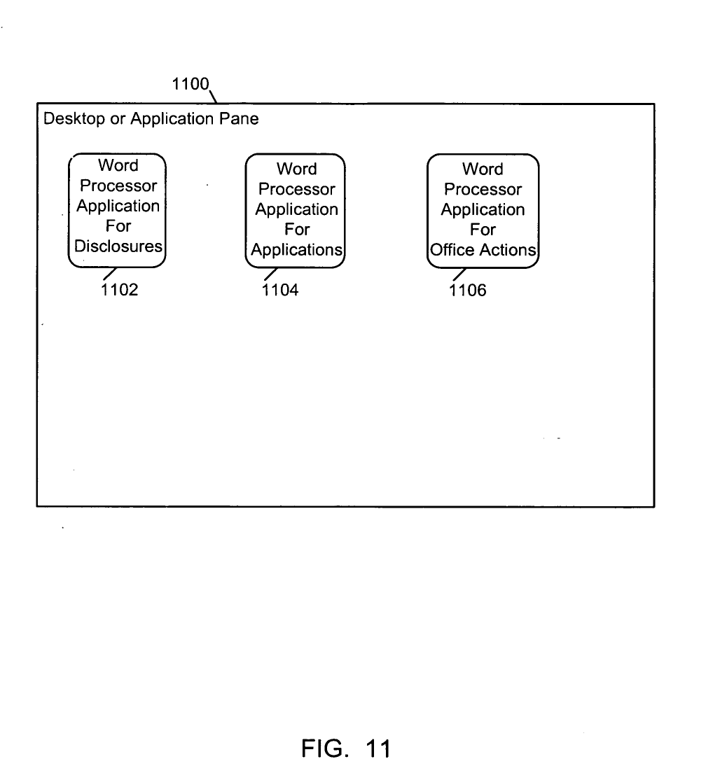

FIG. 11 provides an exemplary GUI display 1100 comprising a plurality of display icons 1102, 1104, and 1106, each associated with a loadable instance of a word processing application 102 according to an embodiment of the subject matter described herein. For example, icon 1102 may be associated with a loadable instance 106 comprising immediate metadata parameter values to configure word processing application 102 suitable for invention disclosure documents. Icon 1104 may be associated with a loadable instance 106 comprising metadata values that configure word processing application 1104 to instantiate an application form to be completed. Icon 1106 may be associated with a loadable instance 106 comprising metadata values that configure word processing application 102 suitable for Office Action documentation. In each case, the configuration, file names, and other settings of the application can be customized using input parameter values.

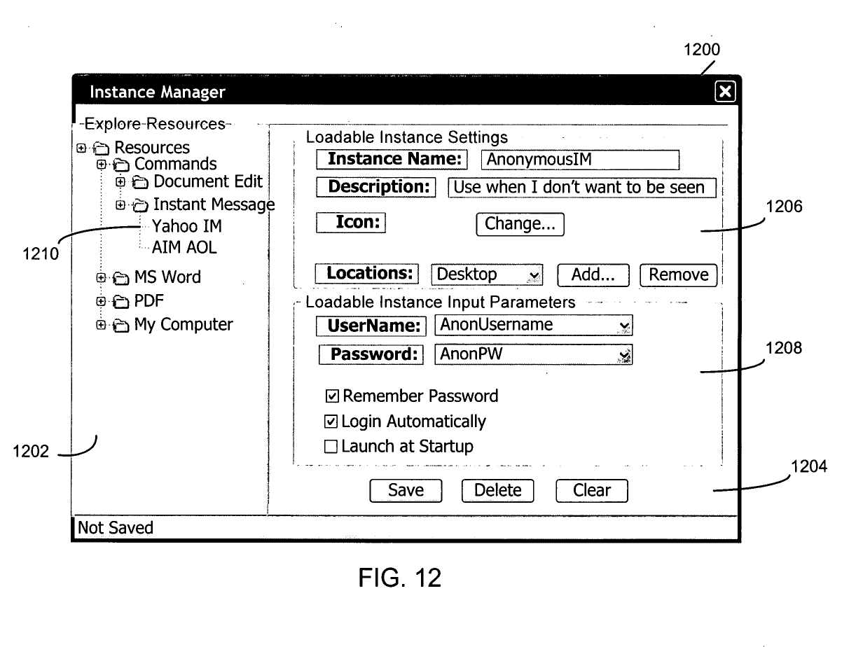

FIGS. 12-14 illustrate exemplary GUI dialog boxes that enable a user to associate a reference to an application with an instance value for each of one or more metadata input parameters to create a loadable instance of the application.

FIG. 12 presents an exemplary GUI dialog box 1200 to permit a user to associate a loadable instance 106 to an application 102 resident in host system 100 according to an embodiment of the subject matter described herein. In FIG. 12, an explorer pane 1202 may allow a user to browse executables resident on host system 100 under a command folder and subfolders organized by purpose. A dialog pane 1204 may present detailed instance configuration information for the application selected in explorer pane 1202, comprising a loadable instance settings pane 1206 and/or a loadable instance input parameters pane 1208. Other parameters or methods associated with the loadable instance may also be presented on the GUI. For example, Yahoo Instant Messenger application 1210 may have been selected in explorer pane 1202. The loadable instance settings pane 1206 may comprise an instance name, a description, a reference to a display icon, and a location designation for the display icon. Loadable instance input parameters pane 1208 may comprise username and password, plus associated configuration parameters such as “Remember Password”, “Login Automatically”, and “Launch at Startup”.

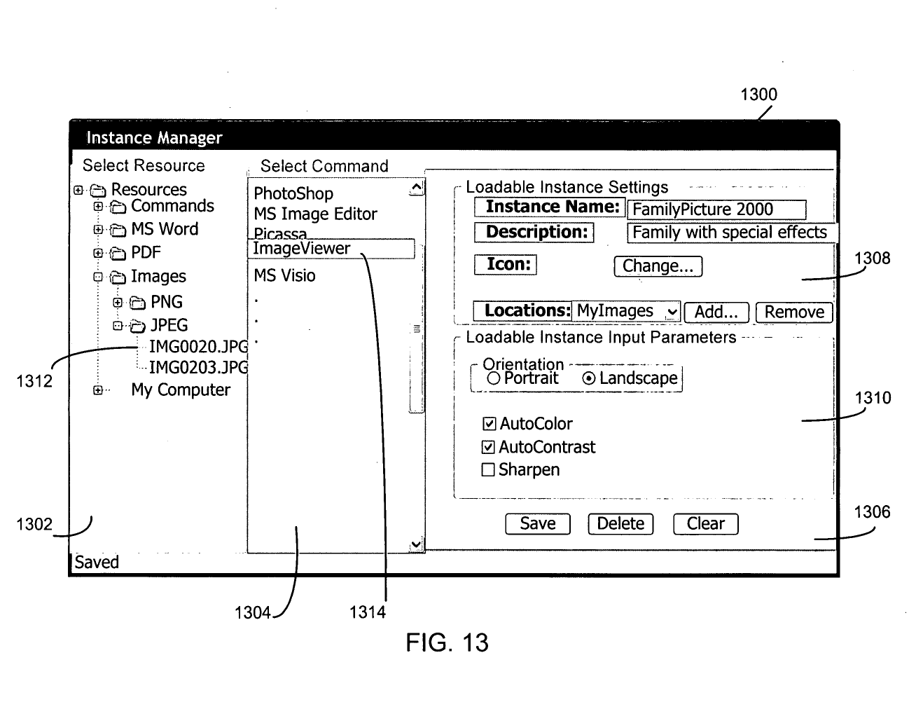

FIG. 13 presents an exemplary GUI dialog box 1300 to permit a user to associate a system resource 104 to a loadable instance 106 of an application 102 according to an embodiment of the subject matter described herein. In FIG. 13, explorer pane 1302 may allow a user to browse system resources on host system 100, including application data files, data stores, registries and directories, and/or resources made available from within other resources such as portions of files or data managed privately by an application. A scrollable list pane 1304 may comprise a list of applications to which a system resource selected in pane 1302 may be associated. A dialog pane 1306 may present detailed instance configuration information for the system resource selected in pane 1302 and the application selected in scrollable list 1304, comprising a loadable instance settings pane 1308 and/or a loadable instance input parameters pane 1310. Other parameters or methods associated with the loadable instance may also be presented on the GUI. For example, a JPEG image file 1312 may have been selected in explorer pane 1302, and an image processing application 1314 may have been selected in scrollable list 1304. The loadable instance settings pane 1308 may comprise an instance name, a description, a reference to a display icon, and a location designation for the display icon. Loadable instance input parameters pane 1310 may comprise image orientation options, plus associated configuration parameters such as “AutoColor”, “AutoContrast”, and “Sharpen”.

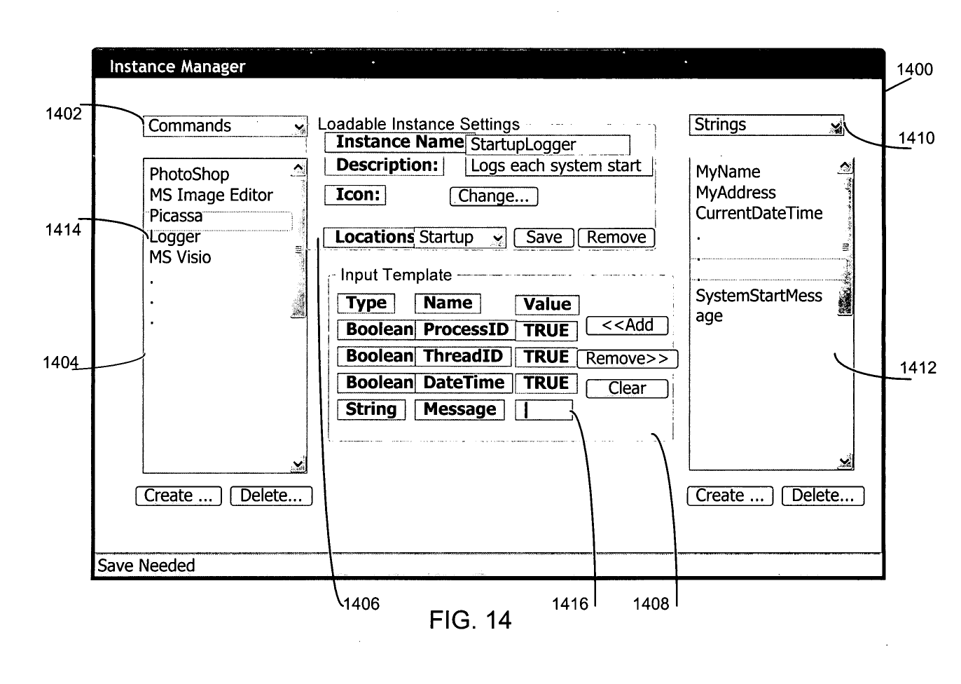

FIG. 14 presents an exemplary GUI dialog box 1400 to permit a user to associate an application 102 or a system resource 104 to a loadable instance 106 of an application 102 according to an embodiment of the subject matter described herein. In FIG. 14, the display may comprise a resource selection drop-down list 1402 and associated display frame 1404, a loadable instance settings frame 1406, an input template frame 1408, and a subfield instance selection drop-down list 1410 and associated display frame 1412. For example, a user may select the Command entry in resource selection list 1402, and a list of applications resident in host system 100 may be displayed in display frame 1404. An application “Logger” 1414 may be selected, causing loadable instance settings frame 1406 and input template frame 1408 to be populated with metadata input parameters defined for a loadable instance 106 associated with the selected application 1414. Fields and sub-fields in frame 1406 may be populated with previously assigned parameter instance values. Fields and sub-fields in frame 1408 may comprise data type definitions for the metadata parameters shown in frame 1406. For example, a Boolean variable definition in frame 1408 may be instantiated with the value “TRUE” or “FALSE”. A string variable definition in frame 1408 may be instantiated with a predefined string constant. For example, sub-field 1416 in frame 1408 may be selected to receive a string definition. In response to selection of sub-frame 1416, subfield selection drop-down list 1410 and associated display frame 1412 may show a list of string definitions already assigned in host system 100. A user may select one of the assigned definitions with which to populate sub-field 1416, or may choose to create a new string definition.

### Exemplary Use of Output Parameter Instance Values

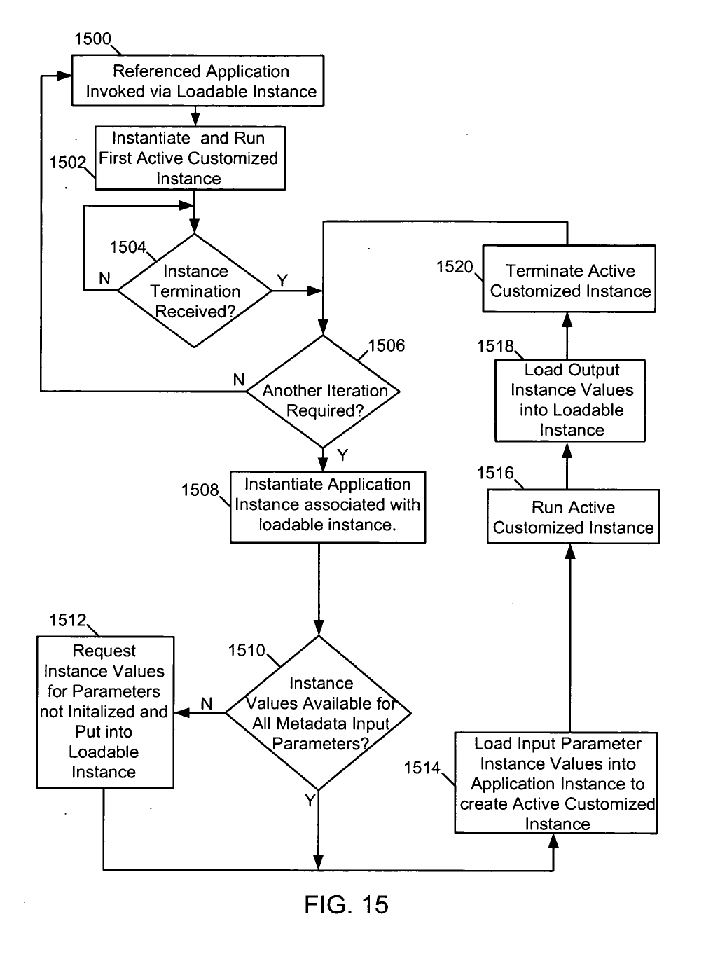

FIG. 15 is a flow diagram of an exemplary process illustrating use of instance values for metadata output parameters from a first active customized instance 240 in addition to instance values for metadata input parameters in a second active customized instance 240 initialized following completion of the first active customized instance 240. In FIG. 15, at block 1500 application 102 referenced in loadable instance 106 may be invoked via loadable instance 106. For example, this instantiation may be provided by activation of a display icon associated with the loadable instance 106 via a reference to the application. In a second exemplary application, this instantiation may be provided by activation of a display icon associated with a system resource associated with the loadable instance 106.

At block 1502, instance manager may instantiate and run a first active customized instance of the application. If the invocation received at block 1500 originated at an icon associated with the loadable instance, instance manager 202 may utilize procedures associated with block 510. If the invocation was received through activation of a system resource associated with the application, instance manager 202 may utilize procedures associated with block 612.

At decision point 1504, instance manager 202 may determine if the first active instance has terminated operation. If the first instance has not termination operation, the process may wait at decision point 1504 until a termination indication is generated. If the first instance has terminated operation, the process may proceed to decision point 1506.

At decision point 1506, instance manager 202 may determine if another active customized instance is to be initialized and run. For example, instance manager 202 may present a GUI screen through UI 228 with a prompt requesting a response from a user. In another exemplary application, instance manager may maintain count the number of times an active instance is run and autonomously decide whether to initialize another instance. If procedures associated with decision point 1506 determine that another active customized instance is not to be initialized and run, the process may proceed to block 1500 to wait for receipt of the next application invocation. If procedures associated with decision point 1506 determine that the first active instance generated instance values for metadata output parameters and another active customized instance is to be initialized and run, the process may proceed to block 1508.

At block 1508, instance manager 202 may create another application instance of application 102 by placing a copy of application 102 system memory 206.

At decision point 1510, instance manager 202 may check the contents of each metadata input parameter field in instance 106 to determine if the field contains a user supplied instance value. If each metadata input field in instance 106 contains an instance value, the process may proceed to block 1514. If one or more input fields in instance 106 contain no specified value and have no associated default value, the process may proceed to block 1512.

At block 1512, instance manager 202 may display each metadata input parameter for which instance 106 does not already contain an instance value. This display may be provided through UI 228 and may also include a prompt requesting input from the user. Instance manager 202 may add any instance values received for the displayed metadata input parameters into instance 106.

At block 1514, instance manager 202 may create an active customized instance 240 by loading a copy of the instance value for each metadata input parameter available from instance 106 into the application instance placed in system memory 206 at block 1508.

At block 1516, active customized instance 240 may initialize, run, and terminate its operating session using any means suitable to host system 200. Active instance 240 may access an application data file 104 associated with referenced application 102 to either read or write contents as appropriate. For example, active instance 240 may provide a word processing function for host system 200 with certain environment options set according to the task that the user wishes to complete.

At block 1518, active customized instance 240 may generate at least one operational result and transfer the at least one result to instance manager 202 for storage in metadata output parameter fields 132-134 in instance 106.

At block 1520, active customized instance 240 may terminate operation using any suitable means. In response to termination of active instance 240, instance manager 202 and database 204 may close instance 106. The process may proceed to decision point 1506 to determine if another active customized instance of application 102 is to be initialized and run.

### Exemplary Application Scenarios

In a first exemplary application, a department manager may work with a plurality of documents due to the breadth of her responsibilities. She may write reports to superiors, review and edit reports from underlings, and receive and consume information in documents received from external organizations. She may wish to create and use a loadable instance referencing a word processing application for each type of document in order to reduce the time required to instantiate an active instance of the word processor and to reduce the change of error due to incorrect configuration parameter settings for a document. In order to create these instances, she may invoke instance manager 202 as a system resource through a GUI. She may select the word processing application from a list of available applications in the system. Instance manager 202 may create a loadable instance 106, populate the instance name field 124 with a name provided by the user, and present the user with a GUI display soliciting a selection for a display icon. In response to selection of a display icon, instance manager 202 may populate application reference field 126 with a reference to the word processing application and populate icon reference field 136 with a reference to the selected icon. Instance manager 202 may retrieve a list of metadata parameters from the application, add the list of metadata parameters to fields 128-134 in instance 106, and present metadata input parameters on the GUI to solicit instance values. Upon receipt of instance values, instance manager 202 may then complete the initialization process for instance 106 and present the display icon on the GUI for further use by the department manager. In this manner, the department manager may create an instance 106 for each of the three types of documents she works with. Each instance 106 may be maintained as an independent entity in instance manager 202, and each may be presented in a system or application presentation location using each respective visual representation.

In a second exemplary application, an engineer may be required to write reports comprising text, drawings, and tables. The engineer may wish to create a complex loadable instance 704 comprising references to a word processing application 706, a spreadsheet application 708, and to a drawing package application 710. The engineer may create this instance by invoking instance manager 202 as a system resource and providing a name to be populated in instance name field 714. Instance manager may provide a list of available display icons from which the engineer may choose for the instance. Instance manager 202 may populate the icon reference field 716 in complex instance 704 with a reference to the selected icon. The engineer may then select the first application to be referenced in complex instance 704 from a list provided at a GUI screen. Instance manager 202 may populate the first application reference field with a reference to the selected application and obtain a list of metadata parameters from the application. Instance manager 202 may display the metadata input parameters on the GUI to solicit instance values from the engineer, and may store any values received from the engineer in complex instance 704. The engineer may populate complex instance 704 with references to the drawing package and spreadsheet applications and may provide instance values for their respective metadata input parameters. Following storage of all application references and associated metadata parameters, instance manager 202 may complete the initialization process for complex instance 704 and present the display icon on the GUI for further use by the engineer.

In another exemplary application, a loadable instance 106 may comprise metadata output parameters for an application. An application 102 may store operational results or other stateful information in these parameters at the completion of an active instance of the application. At a subsequent invocation of application 102, these output parameter values may be added to or replace some or all of to the instance values for the metadata input parameters for the application to further influence the results generated by the application. For example, an application 102 may store a count of the number of times a particular data file associated with the application has been accessed plus a timestamp of the most recent access as metadata output parameters. Application 102 may then test these output parameter values at the start of the next instance to determine if access to the referenced data file is to be permitted.

In yet another exemplary application, the metadata parameter instance values stored in an instance 106 may be read by an application other than the referenced application. For example, a system usage monitor application may access instance 106 to determine the timestamp of the most recent invocation of the application referenced in instance 106 to determine if the application should be removed from active memory. Similarly, a supervisory application may review the instance values of the metadata parameters to determine if the referenced application has valid metadata input parameter instance values and/or if the instance values for the metadata output parameters are within a predefined valid range.

A system for creating an input-value-specific loadable instance of an application may include means for receiving an identifier associated with an application. For example, instance manager 202 may receive an indication from host system 200 through UI 228 that an application has been selected either directly, through activation of an icon associated with the loadable instance 106, or indirectly, through activation of a system resource associated with the loadable instance. Instance manager may use procedures associated with block 300 to receive this message and process it.

A system for creating an input-value-specific loadable instance of an application may include means accessing metadata associated with the application and identifying a permissible input parameter of the application. For example, instance manager 202 may use procedures associated with block 302 to send a query to the referenced application 102 through API 232. This query may be of any form suitable to host system 200 and application 102. Application 102 may provide at least one metadata input parameter for which instance values may be provided in response to the query. Instance manager 202 may place the at least one parameter into instance 106.

A system for creating an input-value-specific loadable instance of an application may include means for presenting the input parameter and receiving a value for the input parameter. For example, instance manager 202 may present the at least one metadata input parameter received from application 102 to a GUI through loadable instance UI 228 using procedures associated with block 304 in order to solicit an instance value for the parameter from the user. Upon receipt of at least one instance value from the user through UI 228, instance manager 202 may add the received at least one instance value to instance 106 using procedures associated with block 304.

A system for creating an input-value-specific loadable instance of an application may include means for creating a loadable instance of the application that, when invoked, loads the application into memory and provides the received value as input for processing by the application, wherein the loadable instance is capable of being visually represented. For example, instance manager 202 may utilize procedures associated with block 306 to collect the contents of fields 124-136 in instance 106 into a format suitable for instance 202, database 204, and host system 200. Instance manager 202 may also solicit selection of a display icon to associate with instance 106 through a GUI display of a list of configured icons as maintained in location manager 234. Upon receipt of a selection from an input device associated with host system 200 through UI 228, instance manager 202 may populate icon reference field 136 in instance 106 with a reference suitable for instance manager 202, database 204, and host system 200.

A system for associating a loadable instance of an application with an input value may include means for creating a loadable instance of an application, the loadable instance including at least one reference for associating with the loadable instance each of the application, a metadata parameter field for identifying an input parameter of the application, a value for the input parameter to be provided as input for processing by the application when the loadable instance is invoked, and a visual representation of the loadable instance for allowing invocation of the loadable instance via a user interface. For example, a loadable instance 106 may be created in instance manager 202 utilizing procedures associated with block 306. Instance manager 202 may instantiate application reference field 126 with a suitable reference to application 102 associated with loadable instance 106 utilizing procedures associated with block 400. Instance manager 202 may query the application associated with the loadable instance for a list of metadata input and output parameters using any method suitable to the application and host system 100, and may instantiate parameter fields 128-134 in loadable instance 106 with a list of parameters received in response to the query utilizing procedures associated with block 402. Instance manager 202 may present received metadata input parameters on a GUI through UI 228 to solicit instance values from a user. In response to receipt of an instance value for a presented input parameter, instance manager 202 may receive the instance value and store it in loadable instance 106 using procedures associated with block 404. Instance manager 202 may solicit identification of a display icon to be associated with loadable instance 106 from a user through UI 228. In response to receipt of an identified icon, instance manager 202 may instantiate field 138 in loadable instance 106 with a suitable reference to the identified icon using procedures associated with block 406.

The methods and systems described herein for creating instances of linked applications may be implemented in a database environment where creating an input-value-specific loadable instance of an application is managed using a database management system (DBMS). For example, a system in accordance with the subject matter described herein may be implemented in the database environment described in a commonly-assigned, co-pending U.S. patent application entitled “Methods, Systems, and Computer Program Products for Providing a Program Execution Environment” filed on even date herewith, the disclosure of which is incorporated herein in its entirety.

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A method for creating an input-value-specific loadable instance of an application, comprising:
providing a graphical user interface for:
receiving an identifier associated with an application;
accessing metadata associated with the application and identifying a permissible input parameter of the application;
presenting the input parameter and receiving a value for the input parameter; and
creating a loadable instance of the application that, when invoked, loads the application into memory and provides the received value as input for processing by the application, wherein the loadable instance is capable of being visually represented.

2. The method of claim 1 comprising providing for invocation of the loadable instance via the visual representation.

3. The method of claim 1 comprising providing for invocation of the loadable instance in response to invocation of a system resource associated with the application.

4. A method for associating a loadable instance of an application with an input value, the method comprising
creating a loadable instance of an application, the loadable instance including at least one reference for associating with the loadable instance each of:
the application;
a metadata parameter field for identifying an input parameter of the application;
a value for the input parameter to be provided as input for processing by the application when the loadable instance is invoked; and
a visual representation of the loadable instance for allowing invocation of the loadable instance via a user interface.

5. The method of claim 4 wherein the loadable instance includes references to a plurality of applications and respective input parameters and input parameter values for each application.

6. The method of claim 5 further comprising providing for invocation of the plurality of applications with a respective value for the input parameter being provided as input for processing by the application in response to invocation of the loadable instance.

7. The method of claim 4 wherein the loadable instance includes reference to a metadata output parameter field for associating an output value generated by the application with the loadable instance.

8. The method of claim 7 comprising providing the output value output from a first loadable instance of the application as input to a second loadable instance of the application.

9. A system for creating an input-value-specific loadable instance of an application, the system comprising:
an instance manager including a graphical user interface, the instance manager operable to receive an identifier associated with an application, access metadata associated with the application, identify a permissible input parameter of the application, present the input parameter, receive a value for the input parameter, and create a loadable instance of the application that, when invoked, loads the application into memory and provides the received value as input for processing by the application; and
the instance manager including a resource manager configured for managing the loadable instance of the application by associating with the loadable instance the application, an input parameter of the application, a value for the input parameter, and an association with a visual representation of the loadable instance of the application.

10. The system of claim 9 wherein the resource manager is configured to associate a system resource associated with the application to provide for invocation of the loadable instance of the application in response to invocation of the system resource associated with the application.

11. The system of claim 9 wherein the resource manager is configured to associate with the loadable instance a plurality of applications and respective input parameters and input parameter values for each application.

12. The system of claim 9 wherein the resource manager is configured to associate with the loadable instance reference to a metadata output parameter field for associating an output value generated by the application with the loadable instance.

13. The system of claim 9 wherein the instance manager is configured to provide the output from a first loadable instance of the application as input to a second loadable instance of the application.

14. A system for creating an input-value-specific loadable instance of an application, the system comprising:
means for receiving an identifier associated with an application;
means for accessing metadata associated with the application and identifying a permissible input parameter of the application;
means for presenting the input parameter and receiving a value for the input parameter; and
means for creating a loadable instance of the application that, when invoked, loads the application into memory and provides the received value as input for processing by the application, wherein the loadable instance is capable of being visually represented.

15. A system for associating a loadable instance of an application with an input value, the system comprising:
means for creating a loadable instance of an application, the loadable instance including at least one reference for associating with the loadable instance each of:
the application;
a metadata parameter field for identifying an input parameter of the application;
a value for the input parameter to be provided as input for processing by the application when the loadable instance is invoked; and
a visual representation of the loadable instance for allowing invocation of the loadable instance via a user interface.

16. A computer program product comprising computer application instructions embodied in a computer readable medium for performing steps comprising:
receiving an identifier associated with an application;
accessing metadata associated with the application and identifying a permissible input parameter of the application;
presenting the input parameter and receiving a value for the input parameter; and
creating a loadable instance of the application that, when invoked, loads the application into memory and provides the received value as input for processing by the application, wherein the loadable instance is capable of being visually represented.

17. A computer program product comprising computer application instructions embodied in a computer readable medium for performing steps comprising:
creating a loadable instance of an application, the loadable instance including at least one reference for associating with the loadable instance each of:
the application;
a metadata parameter field for identifying an input parameter of the application;
a value for the input parameter to be provided as input for processing by the application when the loadable instance is invoked; and
a visual representation of the loadable instance for allowing invocation of the loadable instance via a user interface.
